(19) United States
(12) Patent Application Publication
(10) Pub. No.: US 2023/0366768 A1
(43) Pub. Date: Nov. 16, 2023

(54) GLOVE PRESSURE TESTING DEVICE

(71) Applicant: Norco Industries, Inc., Compton, CA (US)

(72) Inventor: Frank Casale, Fishers, IN (US)

(73) Assignee: Norco Industries, Inc., Compton, CA (US)

(21) Appl. No.: 17/741,807

(22) Filed: May 11, 2022

(51) Int. Cl. G01M 3/02; G01M 3/26

(52) U.S. Cl. CPC G01M 3/027; G01M 3/26

(57) ABSTRACT

A system for determining a leak in a glove is used in conjunction with a supply of compressed air, the system including a regulator in fluid communication with the source of compressed air. The regulator comprises a housing with an air inlet and an air outlet, a two way valve connected to the air inlet and the air outlet, an air flow meter, and a pressure gauge. The system is also provided with a glove adapter that is configured to make an airtight seal with the glove while inflating and testing the glove for leaks.

### BACKGROUND

Special insulated gloves are necessary when working on vehicles with high voltage batteries such as hybrid gasoline/electric and all electric vehicles. These electrical-insulating gloves are made of dielectric materials to protect the worker from electrical shock. For safety reasons the gloves are required to be tested for leaks prior to use to avoid electrical current being transferred to the worker. To check for leaks, the existing solution is a manual air pump device that fills the glove up with air, whereupon the inflated glove is sealed and transferred to soapy water and checked for bubbles. After testing the tech needs to wipe all the water off (hopefully) using a clean rag. This process is cumbersome, inconsistent, and can miss small leaks. A better solution is needed that doesn't require a hand pump and is more repeatable and reliable than the existing technology.

### SUMMARY OF THE INVENTION

The present invention is a device used to verify the integrity of heavy duty dielectric gloves and that does not require that the gloves be dunked in water to establish the absence of holes and leaks. The device begins with a supply of compressed air and further includes a pressure regulator, a pressure gauge, and a flow meter with an indicator to display current flow rate. The regulator includes a valve with 2 positions, one to permit the glove to be filled with pressurized air, and a second position that maintains a constant elevated pressure within the glove. A hose that delivers the air to the glove is attached to an adapter that fits the wrist of the glove to provide a sealed or closed system. The adapter has multiple variations, including an adjustable inflation cuff with a bladder that expands to fit the glove, a mechanical expansion device that expands to fit, or a step adapter that fits different size gloves.

The unit is connected to air supply and the flow meter is the first method of leak check. If the flow meter shows no air passing through the system, then the glove is leak-free. To insure glove meets the specifications, the unit can be changed to position decay check and pressure gauge can be checked for any decay in pressure.

### BRIEF DESCRIPTION OF THE DRAWINGS

FIGS. 1-3 are elevated perspective views of a first embodiment of the present invention; and

FIG. 4 is a schematic diagram of the pump.

### DETAILED DESCRIPTION OF THE PREFERRED EMBODIMENTS

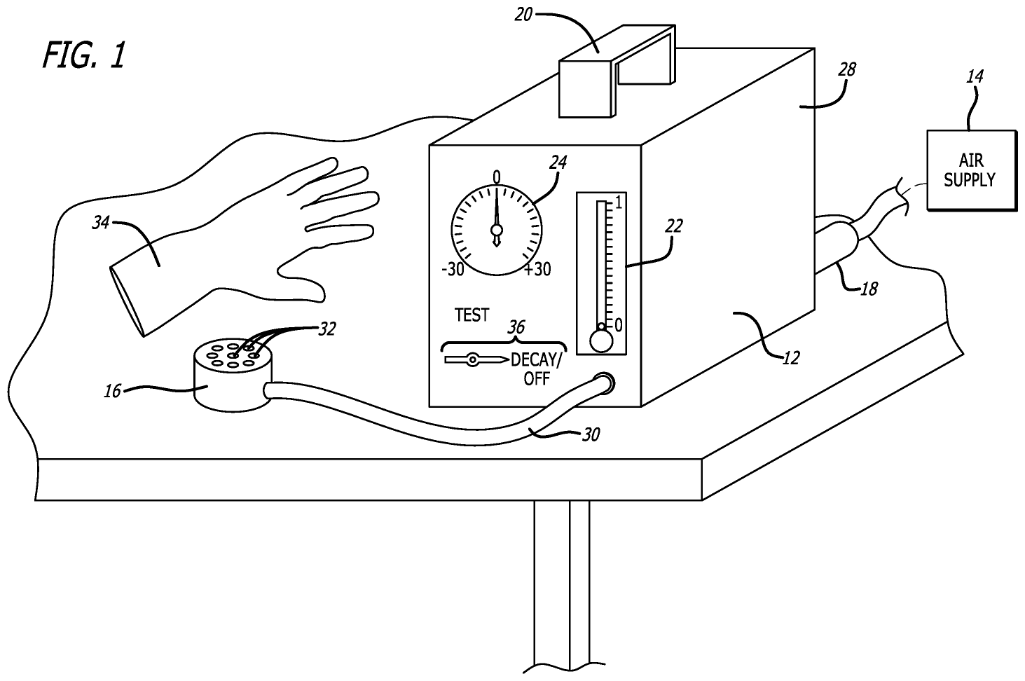

FIGS. 1-3 illustrate a first embodiment of the present invention for evaluating the integrity of a heavy duty glove for holes and leaks. The invention includes an inflation regulator 12 connected by a hose 18 to an air supply 14 that cooperate to deliver air to a controlled flow of air to an adapter 16. The air supply 14 can be a compressed air station typically found in most vehicle service stations or a stand-alone tank of compressed air. The regulator 12 has a sturdy housing 28 and a handle 20 and is considered portable, and on a first forward facing surface is a plurality of gauges including pressure gauge 24 and an air flow meter 22. The air flow meter 22 may be a ball valve, where a ball is disposed in a vertical tube and the presence of air flow will elevated the ball to a position related to a velocity of the flow of air. The regulator 12 includes an outlet air hose 30 that connects to the adapter 16 used to inflate a glove 34, where in one preferred embodiment the adapter 16 is a cylindrical shaped base with holes 32 on an upper surface to allow air to pass into the glove 34 when the glove 34 is attached to the base. The adapter may include various mechanisms for expanding or contracting the outer diameter to ensure a satisfactory seal with the glove, including a frusto-conical shape that mates with multiple sized diameter gloves, a mechanical expander/contractor, an inflatable bladder, etc. The regulator also includes a switch or dial 36 to set the flow rate of air through the system.

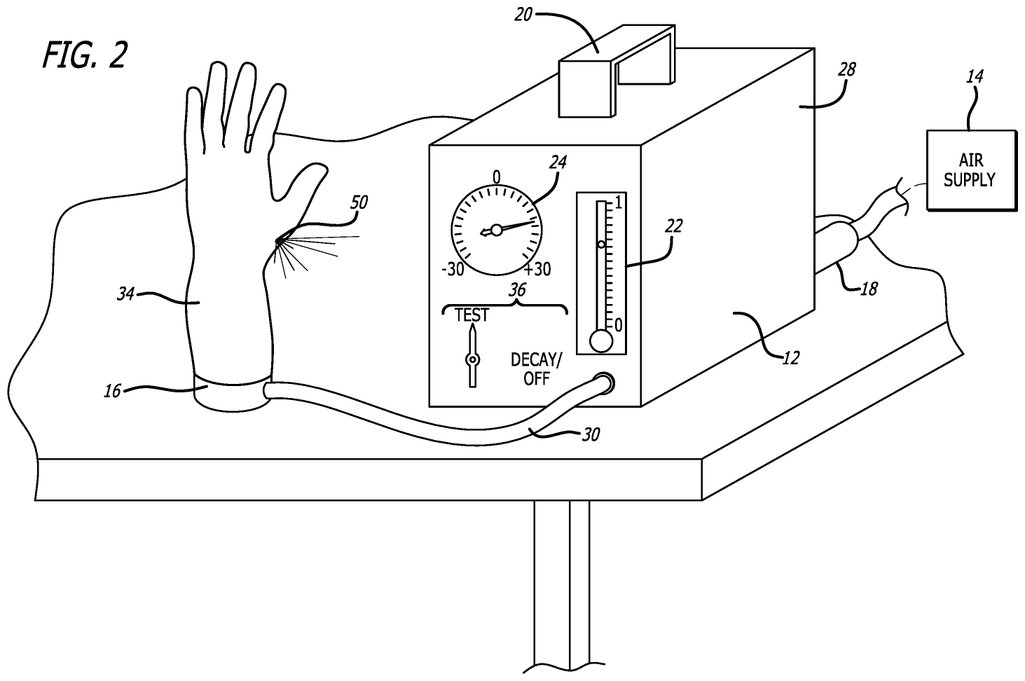

As shown in FIG. 2, to test a glove 34 for leakage, the switch 36 on the regulator 12 is moved to the “test” position to start an airflow though the hose 30 and into the adapter 16. With the glove 34 placed over the adapter 16 to form an airtight seal, the air flowing into the adapter flows into the glove 34 to inflate the glove. The accumulating pressure inside the glove 34 is measured by the pressure meter 24, which is monitored to ensure the pressure in the glove does not exceed a burst or failure value. The pressure meter 24 displays the pressure in the regulator corresponding to the pressure in the glove 34. With the air flowing into the glove 34, a test pressure is ultimately reached that will differ with each type and manufacture of glove.

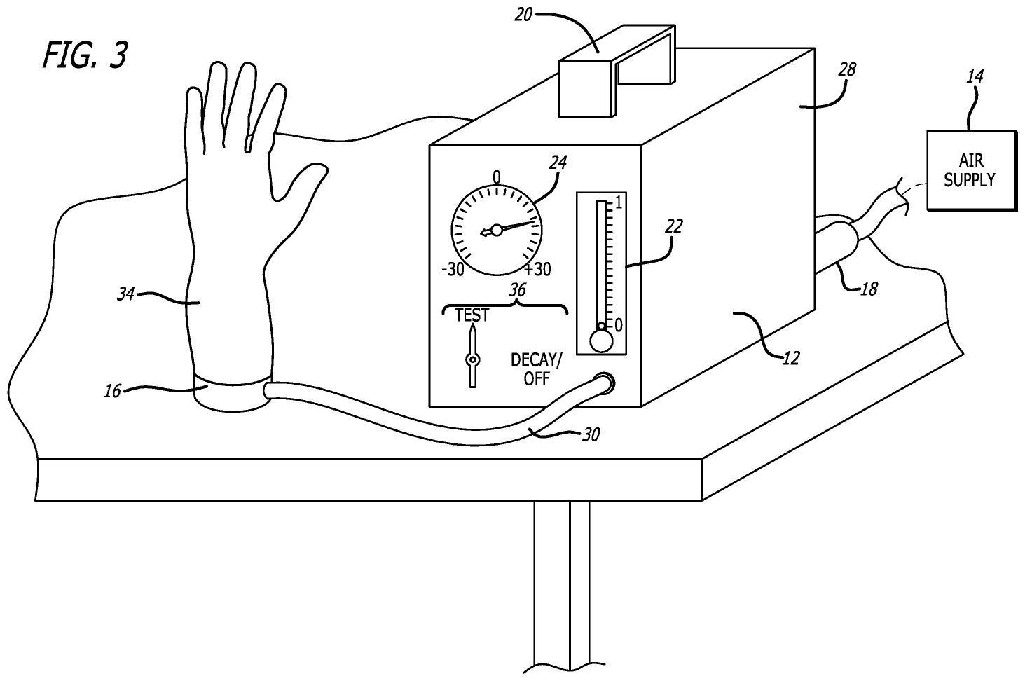

Once the air pressure in the glove reaches its designated test pressure, the air flow meter 22 and pressure gauge 24 will determine whether the glove 34 has a leak 50 or whether the system is closed and no air is escaping. That is, if the air flow meter 22 shows a continual flow of air into the glove 34 without a corresponding rise in air pressure as reflected in the pressure gauge 24, this indicates that air is leaving the system, presumably through a hole in the glove 34. The greater the value of the airflow shown by the air flow meter 22, the larger the leak. If the air flow meter indicates that the airflow has stopped, this means that no air is escaping and the glove's integrity is intact (FIG. 3). Care must be used to make sure the air is not escaping through another location, such as the hose 30, the connection to the adapter 16, or the adapter itself. If it is determined that the glove has a leak, the glove must either be repaired or discarded to prevent injury to a worker using the glove.

The system provides a back-up check to determine a leak, where after the glove is inflated the switch is moved to “decay,” closing off the flow of air to the adapter 16. If there is no leak, the pressure will remain constant since the system is designed to be a closed system. However, if the pressure begins to drop, this indicates that the closed system is in fact open and air is escaping, presumably through a leak in the glove. This secondary check ensures greater reliability when investigating the safety of the gloves being checked.

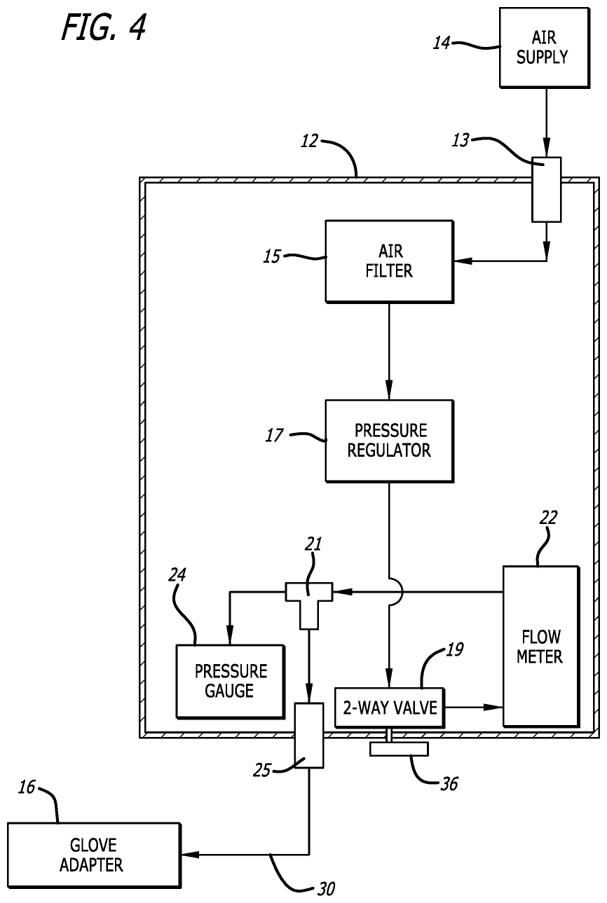

FIG. 4 is a schematic diagram of a first embodiment of the present invention. Air is provided by the air supply 14, which enters the regulator 12 at the inlet port 13. The air may be passed through an air filter 15 before being directed to an air pressure regulator 17 and into a two-way valve 19 controlled by the switch 36. When the switch is in the “test” position as shown in FIG. 2, the air flows into a flow meter 22 where the mass of air flow moving through the system is measured and displayed. The air leaving the air flow meter 22 is directed to a T-valve 21, which provides the pressure gauge 24 with a connection to the closed system. The other outlet of the T valve 21 leads to an outlet port 25 and a hose 30 that feeds the glove adapter 16, which in turn is used to inflate the glove.

Although the foregoing description is based on a specific embodiment, it is to be understood that various modifications and substitutions are available and would be readily appreciated by one of ordinary skill in the art. Therefore, the invention should not be limited to only those components depicted or described herein, but rather by using the words of the appended claims using their customary and ordinary meanings, consistent with but not limited by this description and these drawings.

1. A system for determining a leak in a glove, comprising:
a source of compressed air;
a regulator in fluid communication with the source of compressed air, the regulator including a housing with an air inlet and an air outlet, a two way valve connected to the air inlet and the air outlet, an air flow meter, and a pressure gauge;
an adapter connected by a hose to the regulator, the adapter configured to make an airtight seal with the glove to inflate the glove to a testing pressure;
wherein the air flow meter is used to determine a presence of a leak in the glove by indicating air in an otherwise closed system.

2. The system of claim 1, wherein the air flow meter is a ball disposed in a vertical tube.

3. The system of claim 1, further comprising an air filter in the regulator.

4. The system of claim 1, wherein the two way valve is a T valve.

5. The system of claim 1, wherein the adapter has a cylindrical base.

6. The system of claim 5, wherein the adapter includes a plurality of airholes on an upper surface.

7. The system of claim 1, further comprising a switch on the housing to set the regulator to either a test condition or a decay condition.
